(19) United States
(12) Patent Application Publication
(10) Pub. No.: US 2026/0120231 A1
(43) Pub. Date: Apr. 30, 2026

(54) SYSTEMS AND METHODS FOR VIDEO STABILIZATION AND OBJECT DETECTION

(71) Applicant: CoVar, LLC

(72) Inventor: Peter A. TORRIONE, Wilmington, DE (US)

(21) Appl. No.: 18/932,408

(22) Filed: Oct. 30, 2024

(51) Int. Cl. G06T 3/147; G06T 7/246; G06T 7/33; G06T 7/38; G06T 7/80; G06V 10/24; G06V 10/82; G06V 20/52

(52) U.S. Cl. CPC G06T 3/147; G06T 7/248; G06T 7/337; G06T 7/38; G06T 7/80; G06V 10/247; G06V 10/82; G06V 20/52; G06T 2207/10016; G06T 2207/20016; G06T 2207/20081; G06T 2207/20084; G06T 2207/30232

(57) ABSTRACT

The present embodiments include systems and methods for stabilizing video content and object detection. The system can include an image processor. The image processor can receive image frames, divide each into sub-images, identify keypoints, match keypoints from a current frame to a previous frame thus stabilizing the image, and apply an object detection algorithm.

### FIELD OF THE DISCLOSURE

The present disclosure relates to systems and methods for video stabilization and object detection.

### BACKGROUND

In the motion tracking and objection detection technology space, it is critical for advanced target detection capabilities to effectively locate and identify targets including humans, crowds, ground vehicles, and air-vehicles. While off-the-shelf deep learning architectures such as YOLO and CenterNet can successfully detect well-resolved objects with many pixels on target, the challenge lies in detecting distant targets that are often difficult to resolve and may not be discernible in a single image. Unlike automated systems, human observers have the innate ability to detect distant targets when watching a video, even if these targets only occupy a few pixels on the screen. This human capability highlights the need for innovative target detection deep architectures specifically designed for military applications. These architectures should be capable of processing video data and utilizing multiple frames of information to detect small moving targets that would otherwise go unnoticed. Addressing this technological problem requires the development of a novel deep learning solution that leverages the temporal and contextual information present in video sequences. By analyzing the movement patterns and subtle changes across multiple frames, the proposed architecture aims to enhance the ability to detect and identify distant targets, providing crucial information for military operations.

Through the implementation of this technology, object detection systems can achieve robust and reliable target detection, enabling them to effectively identify and track enemy objects, even under challenging conditions. This innovative solution has the potential to significantly enhance surveillance capabilities and contribute to improved situational awareness and operational success.

### SUMMARY OF THE DISCLOSURE

In some aspects, the techniques described herein relate to a method for tracking objects in a video including: receiving, by a processor, one or more frames of a video; dividing, by the processor, each frame of a video into non-overlapping sub-images; extracting, by the processor, keypoints from each sub-image; finding, by the processor, keypoint matches between the keypoints and one or more predetermined features, wherein the keypoint matches occur only between keypoints within the same sub-image of a prior frame and a current frame; estimating, by the processor, an affine transformation by analyzing the resulting keypoint matches; and align, by the processor, the prior frame to the current frame using the affine transformation.

In some aspects, the techniques described herein relate to a video stabilization system including: a processor configured to: receiving one or more frames of a video; dividing each frame of a video into non-overlapping sub-images; extracting keypoints from each sub-image; finding keypoint matches between the keypoints and one or more predetermined features, wherein the keypoint matches occur only between keypoints within the same sub-image of a prior frame and a current frame; estimating an affine transformation by analyzing the resulting keypoint matches; and align the prior frame to the current frame using the affine transformation.

In some aspects, the techniques described herein relate to a non-transitory computer readable medium containing computer executable instructions that, when executed by a wearable device including a processor, configure the computer hardware arrangement to perform procedures including: receiving one or more frames of a video; dividing each frame of a video into non-overlapping sub-images; extracting keypoints from each sub-image; finding keypoint matches between the keypoints and one or more predetermined features, wherein the keypoint matches occur only between keypoints within the same sub-image of a prior frame and a current frame; estimating an affine transformation by analyzing the resulting keypoint matches; and align the prior frame to the current frame using the affine transformation.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is a diagram illustrating system according to an exemplary embodiment.

FIG. 2 is a flowchart illustrating a method according to an exemplary embodiment.

FIG. 3 is a flowchart illustrating a method according to an exemplary embodiment.

FIGS. 4A and 4B are diagrams illustrating a process according to an exemplary embodiment.

FIG. 5 is a flowchart illustrating a method according to an exemplary embodiment.

FIG. 6 is a diagram illustrating a neural network according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The invention relates generally to systems and methods that provide video stabilization and object detection using only a few frames from a video. The present embodiments aim to provide a technological solution to the following technological problem: When cameras move significantly from frame-to-frame, the image data in each frame at pixel (i, j) is radically different from the data in the previous frame. This hinders the detection of distant (few-pixel) moving targets. Performance is improved if the video can be stabilized somewhat prior to detecting these distant targets.

As a solution to this problem, the present embodiments divide each frame of a video into smaller sections called sub-images. From each of these sub-images, important points called keypoints are identified. These keypoints can be specific spots that stand out in each sub-image. In some embodiments, a known method called Harris corner detector is used to find these keypoints. In still other embodiments, descriptors are created using the raw pixel values in a patch around each keypoint. These descriptors capture the unique characteristics of each keypoint and its surroundings. The next step is to find matches between keypoints in the previous frame and the current frame. However, to ensure accurate matches, an algorithm only allows keypoints to be matched within the same sub-image between the previous and current frames. This constraint helps in getting reliable matches. Once the matches are found, an overall transformation called an affine transformation is estimated. This transformation represents the changes in position, rotation, and scale between the previous frame and the current frame. It accounts for the camera movement between the two frames. The estimated affine transformation is then used to warp or adjust the previous frame. By applying the transformation, the historical frame is aligned with the current frame, compensating for the camera motion. This alignment helps in making the video smoother and reducing the effects of camera movement and camera shake. Once the video has been stabilized, an object detection algorithm such as a neural network can identify and track objects present in the video.

Systems and methods of the present disclosure provide numerous advantages. By dividing each frame into sub-images and matching keypoints within the same sub-image, the invention ensures more accurate and reliable matches. This approach reduces the likelihood of false matches and improves the overall tracking accuracy. The estimation of an affine transformation compensates for camera movement, including changes in position, rotation, and scale. This robustness to camera motion helps in stabilizing the video and reducing the effects of camera shake, resulting in smoother and more visually appealing footage. By aligning the previous frame with the current frame using the estimated affine transformation, the invention effectively stabilizes the video. This alignment reduces abrupt changes caused by camera movement, resulting in a smoother video output. The use of sub-images and keypoints allows for a more targeted analysis and processing approach. Instead of analyzing the entire frame, the invention focuses on specific regions of interest, which can reduce computational complexity and improve the efficiency of the motion tracking system. Once the video is stabilized, the invention enables the application of object detection algorithms, such as neural networks, to identify and track objects present in the video. This integrated functionality enhances the capabilities of the motion tracking system, allowing for automated and accurate object tracking.

Additionally, the combination of video stabilization with a motion tracking algorithm yields several technological improvements over conventional systems and methods. Video stabilization reduces the effects of camera motion and shake, resulting in a more stable and clearer video feed. This improved video quality enhances the performance of object detection algorithms. With reduced motion blur and unwanted camera movement, the algorithm can more accurately identify and track objects in the video frames. This leads to higher detection accuracy and fewer false positives or missed detections compared to conventional systems. By aligning the frames and stabilizing the video, the invention provides a consistent and smooth visual input to the object detection algorithm. This stability allows for more reliable object tracking over time. Objects can be accurately tracked as they move through consecutive frames, providing a continuous and uninterrupted tracking experience. Conventional systems that lack video stabilization may struggle to track objects consistently due to the presence of camera shake or erratic motion. The combination of video stabilization and object detection algorithm improves the user experience by providing smoother and more visually appealing video output. Users can view stabilized videos with accurately tracked objects, leading to a more immersive and informative experience. Conventional systems without video stabilization may produce jittery or unstable videos, negatively impacting the user's perception and understanding of the tracked objects.

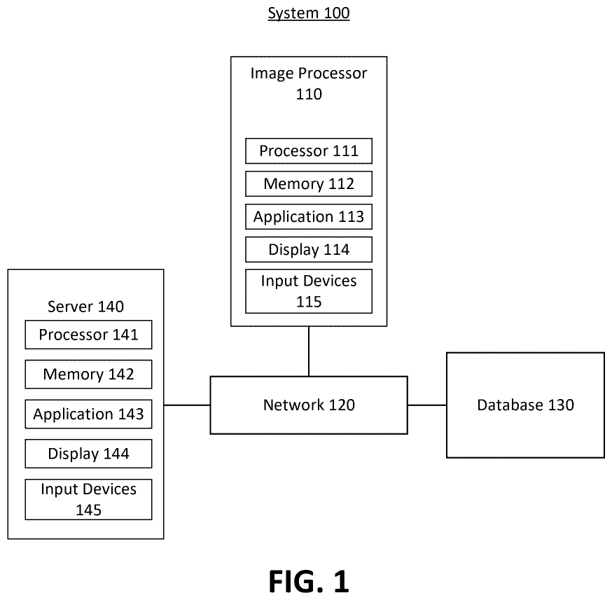

FIG. 1 illustrates a system 100 according to an exemplary embodiment. The system 100 may comprise an image processor 110, a network 120, a database 130, and a server 140. Although FIG. 1 illustrates single instances of components of system 100, system 100 may include any number of components.

System 100 may include an image processor 110. The image processor 110 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. A wearable smart device can include without limitation a smart watch.

The image processor 110 may include a processor 111, a memory 112, and an application 113. The processor 111 may be a processor, a microprocessor, or other processor, and the image processor 110 may include one or more of these processors. The processor 111 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the image processor 110 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 112 may be configured to store one or more software applications, such as the application 113, and other data, such as user's private data and financial account information.

The application 113 may comprise one or more software applications, such as a mobile application and a web browser, comprising instructions for execution on the image processor 110. In some examples, the image processor 110 may execute one or more applications, such as software applications, that enable, for example, network communications with one or more components of the system 100, transmit and/or receive data, and perform the functions described herein. Upon execution by the processor 111, the application 113 may provide the functions described in this specification, specifically to execute and perform the steps and functions in the process flows described below. Such processes may be implemented in software, such as software modules, for execution by computers or other machines. The application 113 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The image processor 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the image processor 110 that is available and supported by the image processor 110, such as a touch-screen, keyboard, mouse, cursor-control device, touch-screen, microphone, digital camera, video recorder or camcorder. These devices may be used to enter information and interact with the software and other devices described herein.

System 100 may include one or more networks 120. In some examples, the network 120 may be one or more of a wireless network, a wired network or any combination of wireless network and wired network, and may be configured to connect the user device 110, the server 120, and the database 130. For example, the network 120 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 120 may include, without limitation, telephone lines, fiber optics, IEEE Ethernet 902.3, a wide area network, a wireless personal area network, a LAN, or a global network such as the Internet. In addition, the network 120 may support an Internet network, a wireless communication network, a cellular network, or the like, or any combination thereof. The network 120 may further include one network, or any number of the exemplary types of networks mentioned above, operating as a stand-alone network or in cooperation with each other. The network 120 may utilize one or more protocols of one or more network elements to which they are communicatively coupled. The network 120 may translate to or from other protocols to one or more protocols of network devices. Although the network 120 is depicted as a single network, it should be appreciated that according to one or more examples, the network 120 may comprise a plurality of interconnected networks, such as, for example, the Internet, a service provider's network, a cable television network, corporate networks, such as credit card association networks, and home networks. The network 120 may further comprise, or be configured to create, one or more front channels, which may be publicly accessible and through which communications may be observable, and one or more secured back channels, which may not be publicly accessible and through which communications may not be observable.

System 100 may include a database 130. The database 130 may be one or more databases configured to store data, including without limitation, private data of users, financial accounts of users, identities of users, transactions of users, and certified and uncertified documents. The database 130 may comprise a relational database, a non-relational database, or other database implementations, and any combination thereof, including a plurality of relational databases and non-relational databases. In some examples, the database 130 may comprise a desktop database, a mobile database, or an in-memory database. Further, the database 130 may be hosted internally by the server 140 or may be hosted externally of the server 140, such as by a server, by a cloud-based platform, or in any storage device that is in data communication with the server 140.

The server 140 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 140 may include a processor 141, a memory 142, and an application 143. The processor 141 may be a processor, a microprocessor, or other processor, and the server 140 may include one or more of these processors. The server 140 can be onsite, offsite, standalone, networked, online, or offline.

The processor 141 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 141 may be coupled to the memory 142. The memory 142 may be a read-only memory, write-once read-multiple memory or read/write memory, e.g., RAM, ROM, and EEPROM, and the server 140 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 142 may be configured to store one or more software applications, such as the application 143, and other data, such as user's private data and financial account information.

The application 143 may comprise one or more software applications comprising instructions for execution on the server 140. In some examples, the server 140 may execute one or more applications, such as software applications, that enable, for example, network communications with one or more components of the system 100, transmit and/or receive data, and perform the functions described herein. Upon execution by the processor 141, the application 143 may provide the functions described in this specification, specifically to execute and perform the steps and functions in the process flows described below. Such processes may be implemented in software, such as software modules, for execution by computers or other machines. The application 143 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 140 may further include a display 144 and input devices 145. The display 144 may be any type of device for presenting visual information such as a computer monitor, a flat panel display, and a mobile device screen, including liquid crystal displays, light-emitting diode displays, plasma panels, and cathode ray tube displays. The input devices 145 may include a touch-screen, keyboard, mouse, cursor-control device, touch-screen, microphone, digital camera, video recorder or camcorder. These devices may be used to enter information and interact with the software and other devices described herein. The server may be a combination of one or more cloud computing systems such as public clouds, private clouds, and hybrid clouds.

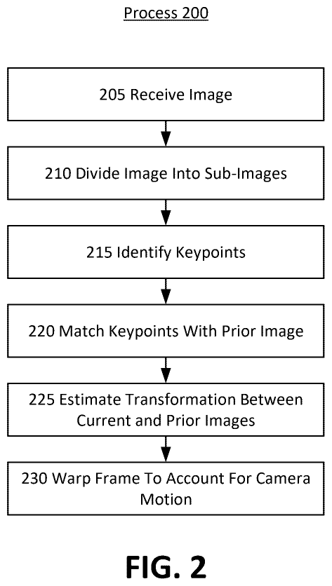

FIG. 2 is a flowchart illustrating a method according to an exemplary embodiment. The method can include without limitation an image processor, network, database or data storage unit, and a server. These elements are discussed with further reference to FIG. 1. The processor described in the process 200 can be associated with the image processor and/or the server.

In action 205, a processor can receive one or more images. The one or more images can include one or more frames from a video. The images can be received in one-by-one, in batches, or continuously. The images can be received or a wired or wireless network discussed with further reference to FIG. 1. The images can be received from an image sensor or image capture device, including without limitation a camera as well as other devices associated with a camera including without limitation an inertial measurement unit (IMU). In some embodiments, the image processor can be associated with the camera itself. For example, the camera can further include an image processor which is the hardware component that performs various operations on the raw image data captured by the camera sensor. This can include tasks such as image enhancement, noise reduction, compression, and feature extraction. The camera can further include a memory which stores the processed image data and any other relevant data, such as metadata or image annotations. The camera can also include any control electronics which manage the camera's operation, including settings such as exposure time, aperture, and ISO sensitivity. The camera can further include any power source necessary to provide the energy needed to operate the camera.

Upon receiving the images, the processor in action 210 can divide the images into sub-images. This action can be applied at least to a current frame (e.g. a frame at t=0) and one or more previous frames. The sub-images are different images themselves contained in the image. The sub-images can be of any suitable number, ranging from as few as two sub-images to several dozen sub-images. In some embodiments, the sub-images can be arranged as equally space rows and columns, e.g. three rows and four columns creating twelve sub-images. In some embodiments, the sub-images may be overlapping, and in still other embodiments the sub-images can be non-overlapping. Dividing the image frames into sub-images allows for a more targeted analysis of specific regions of interest. Instead of processing the entire frame, the invention can focus on smaller sub-images, reducing the computational load. This can result in faster processing times compared to analyzing the entire frame in conventional systems. By efficiently allocating computational resources, the invention improves the overall speed and efficiency of the process. By analyzing sub-images individually, the invention can focus on capturing and matching keypoints within each specific region. This localized analysis can lead to more accurate keypoint detection and matching, as the algorithm concentrates on the distinctive features and characteristics within smaller image sections. This precision improves the overall accuracy of subsequent processes such as affine transformation estimation and object tracking.

Having divided the images into sub-images, the processor in action 215 can identify one or more keypoints in one, some, or all of the sub-images. Generally, these keypoints are specific spots in each sub-image that stand out. These keypoints can be identified, for example, by the Harris corner detector. In some embodiments, the processor can also identify one or more descriptors associated with each keypoint. Generally, descriptors are small pieces of information extracted from the keypoints. In this case, the descriptors are created using the raw pixel values in a patch around each keypoint. These descriptors capture the unique characteristics of each keypoint and its surroundings.

Having identified or more keypoints, the processor in action 220 can find matches between keypoints in a previous frame and the current frame. However, to ensure accurate matches, the processor only allows keypoints to be matched within the same sub-image between the previous and current frames. This constraint helps in getting reliable matches. Keypoints are specific points or regions in an image that have unique visual characteristics, such as corners, edges, or blobs. Keypoint detectors, such as the Scale-Invariant Feature Transform (SIFT) or Speeded-Up Robust Features (SURF), are employed to identify these distinctive points in each frame of the video sequence. Once keypoints are detected, descriptors are computed to describe the local appearance or neighborhood around each keypoint. These descriptors capture the visual information, such as gradient orientations or intensity patterns, that make the keypoints distinctive. Examples of feature descriptors include Histogram of Oriented Gradients (HOG) and Binary Robust Invariant Scalable Keypoints (BRISK). The keypoint descriptors from one frame are compared with the descriptors from subsequent frames to find matches. The goal is to establish correspondences between keypoints that represent the same visual feature across frames, despite changes in scale, rotation, or illumination. Various techniques can be used for keypoint matching, such as brute-force matching, nearest neighbor matching, or more advanced methods like the Random Sample Consensus (RANSAC) algorithm. These techniques aim to find the best matching keypoints based on descriptor similarity or distance metrics.

Once the matches are found, the processor in action 225 makes an overall transformation called an affine transformation. This transformation represents the changes in position, rotation, and scale between the previous frame and the current frame. It can account for the camera movement between the two or more frames. In action 230, the estimated affine transformation is then used to warp or adjust the previous frame. By applying the transformation, the historical frame is aligned with the current frame, compensating for the camera motion. This alignment helps in making the video smoother and reducing the effects of camera shake.

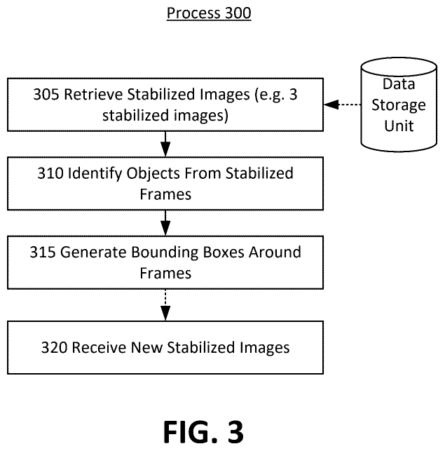

FIG. 3 is a method flowchart illustrating a method according to an exemplary embodiment. The method can include an image processor, database or data storage unit, and a server as discussed with further reference to FIG. 1.

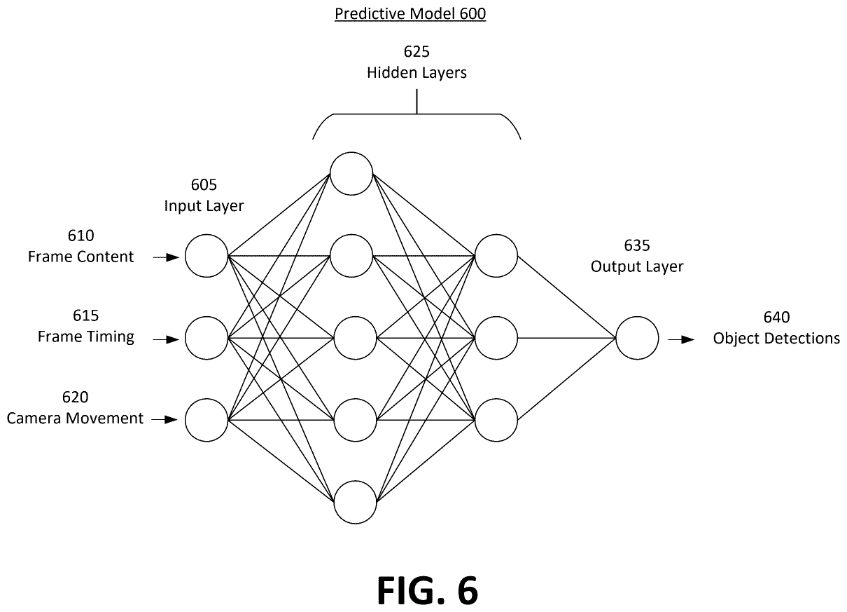

To detect objects, particularly moving objects, the processor can use one or more object detection algorithms. In some embodiments, a moving target indication (MTI) algorithm can be used. MTI works by analyzing changes in pixel values over time to identify and track moving objects within an image or video stream. In some embodiments, the MTI algorithm can include as a convolutional neural network such as CenterNet. This network simplifies the detection process by focusing on center points and generating a heatmap that represents the likelihood of object centers at different locations in the image. This heatmap is generated using a convolutional neural network (CNN), which significantly reduces the computational complexity compared to the multi-stage processes of conventional methods. In some embodiments, the MTI algorithm can also include one or more backbone networks such as DLA 34 or MobileNet. The main idea behind DLA is to leverage features from multiple layers of a CNN to capture both low-level and high-level information about objects. By aggregating feature maps from different layers, DLA aims to preserve fine-grained details as well as high-level semantic information, enabling more accurate object detection and tracking. DLA achieves this by employing a top-down architecture, where feature maps from higher-resolution layers are upsampled and fused with feature maps from lower-resolution layers. This aggregation of features allows DLA to benefit from the multi-scale representations learned by the CNN. MobileNet is a convolutional neural network architecture specifically designed for efficient and lightweight image recognition tasks, including object detection and motion tracking. CNNs are discussed with further reference to FIG. 6.

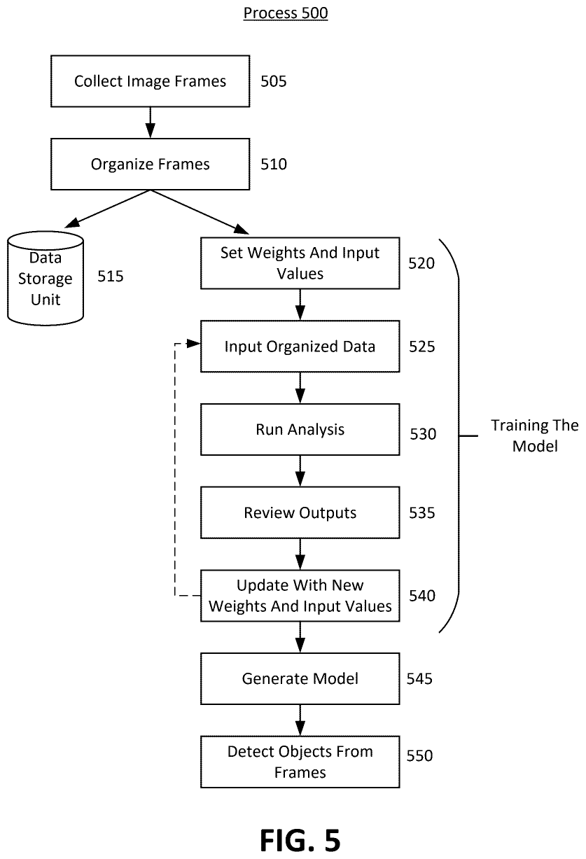

In action 305, the processor retrieves three stabilized images or stabilized frames. These frames can be received or retrieved from a data storage unit or database. These frames may be the same stabilized frames from action 230. These frames are captured at different times. As a nonlimiting example: the current time (t0), 0.25 seconds before the current time (t0−0.25 s), and 0.5 seconds before the current time (t0−0.5 s). These frames may be adjusted by the processor to make the video look smoother and reduce camera shake and camera movement. The algorithm is trained to analyze these three stabilized frames and determine, in action 310, where objects are located in the current frame. Having recognized the objects, processor and/or the algorithm can generate one or more bounding boxes around the objects. The algorithm has been trained to recognize objects by looking at patterns between past and current frames with respect to moving objects and camera movement. The training of the algorithm is discussed with further reference to FIG. 5 and FIG. 6. During the training process, the network can be set to focus on specific types of objects. For example, it can be trained to detect objects that are either small or large, or objects that are moving either fast or slow. These objects can include without limitation: one or more human beings, including crowds for crow-monitoring and security surveillance; other vehicles such as a cars, motorcycles, bicycles, golf carts, four-wheelers, snow mobiles, helicopters, planes, and other vehicles; wildlife; drones including unmanned aerial vehicles (UAVs); and industrial equipment such as machinery.

In some embodiments, only three frames are needed to detect any object within the frames. However, in other embodiments, a queue of the last several frames (for example, fifteen frames) is stored in memory. This allows the algorithm to keep track of keypoints and keypoint descriptors associated with each frame in the queue. In some embodiments, to generate detections for the current frame, only frames 1, 7, and 15 from the queue are used for processing. This corresponds to the current frame and frames that were captured 0.25 and 0.5 seconds ago, assuming a frame rate of 30 frames per second. By maintaining the queue of frames, the algorithm does not need to recalculate keypoints and descriptors for each frame. Otherwise, it would have to recalculate the keypoints when a frame moves through the queue. Thus, the processor saves time and processing power.

In other embodiments, the MTI algorithm can perform other functions to detect objects from the one or more frames: To distinguish between static and moving regions, a threshold can be applied to the differences obtained from frame differencing. Pixels with differences above the threshold are considered part of the moving regions. Thresholded differences may be subjected to additional processing steps, such as noise removal and morphological operations, to enhance the detected regions. These steps help in grouping adjacent pixels with significant differences into connected regions or blobs.

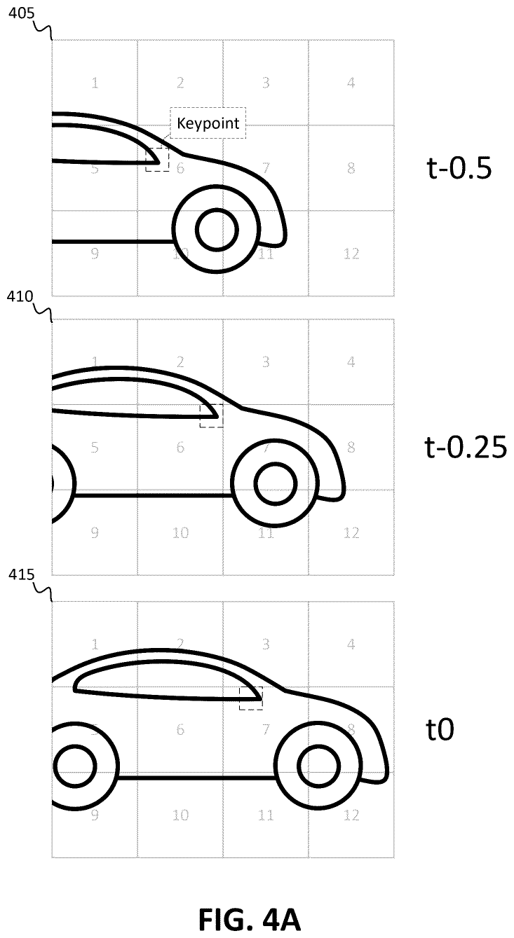

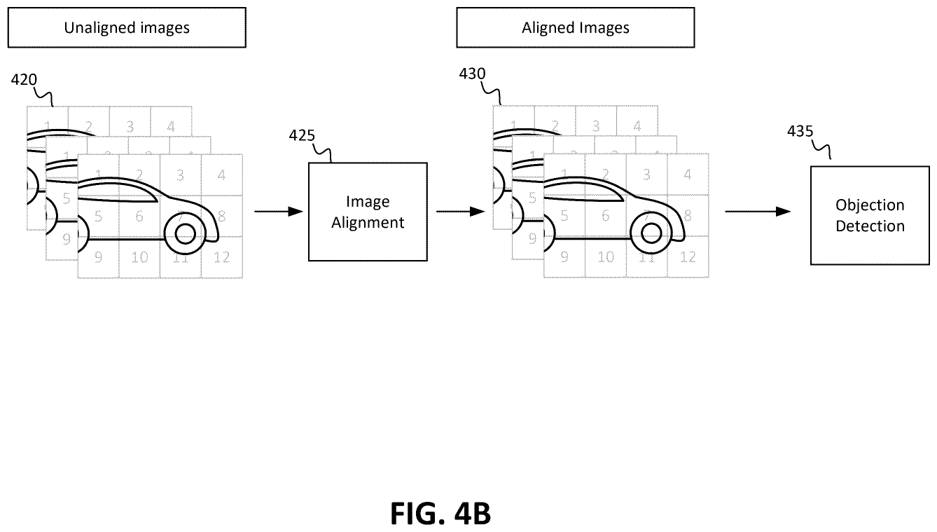

FIGS. 4A and 4B illustrate the process of identifying keypoints from three different frames. This process can include without limitation the image processor, database or data storage unit, and server as discussed with further reference to FIG. 1.

To perform video stabilization, the image processor may receive as inputs three frames 405, 410, and 415. Frame 415 is the current frame, e.g. the frame at time t=0. Frames 410 and 405 are past frames, e.g. frame 410 is at t=−0.25, and frame 405 is at t=−0.5. Each of these frames are divided into twelve nonoverlapping sub-images via three rows and four columns. In other embodiments, fewer or more sub-images can be divided out of the frames, and the sub-images may be overlapping.

In frame 405, a keypoint is identified at a corner of a car window. Although only one keypoint is identified in FIG. 4A, it is understood that any number of keypoints can be identified in a single frame as well as other frames. The keypoint can be identified in sub-image 6. In the next frame 410, the keypoint is again in sub-image 6. To ensure accurate matches, the algorithm and/or processor only allows keypoints to be matched within the same sub-image between the previous and current frames. This constraint helps in getting reliable matches. Thus, the keypoint in frames 405 and 410 will be matched by the video stabilization process. In frame 415, the keypoint that was in sub-image 6 has now moved into sub-image 7, so the processor will find a different key point for sub-image 6.

Referring to FIG. 4B, the alignment or stabilization of the images can be done before object detection is performed. In 420, the image processor or server receives one or more unaligned or unstabilized images. These may be one or more raw images or image frames received from a camera or image sensor. The images are aligned in 425 according to the systems and methods discussed with further reference to FIGS. 2 and 4A. After having produced the aligned images in 430, the algorithm can finally initiate object detection in step 435.

FIG. 5 is a flowchart illustrating the process 500. The process 500 describes the training process for an exemplary predictive model or neural network suitable for predicting and calculating a coverage amount associated with a lease-applicant. The process can begin with action 505 when the image frames are received. The collection of image frames can be performed by the image processor or application associated with a user device or server. The image frames can be transmitted over a wired or wireless network. The data may have been previously gathered and stored in a database or data storage unit in which case the processor or application can retrieve the data from the data storage unit. At action 510, the processor or application can organize the image frames into discernable categories which can be predetermined by the user or created by the predictive model. At action 515, the image frames can be transmitted to the data storage unit. The data storage unit can be associated with the image processor or server. The image frames can be transmitted over a wired network, wireless network, or one or more express buses. The processor or application can proceed with training a predictive model in actions 520 through 540. The training portion can have any number of iterations. The predictive model can comprise one or more neural network described with further reference to FIG. 6.

The training portion can begin with action 520 when the weights and input values are set by the user or by the model itself. Furthermore, the weights can be the predetermined connections between the inputs and the hidden layers described with further reference to FIG. 5. The input values are the values that are fed into the neural network. The input values may be discerned by the different categories created in action 510, although other distinct input values may be discerned. In action 525, the data is in inputted in the neural network, and in action 830 the neural network analyzes the data according to the weights and other parameters set by the user. As a nonlimiting example, the user may create the stipulation that only three image frames should be used at any one time to preserve time and energy. In action 535, the outputs are reviewed. The outputs can include one or more object detections, e.g. a vehicle moving across the image frames. In action 540, the predictive model may be updated with new data and parameters. The new data can be collected by the processor in a similar fashion to actions 505 and 510. Though it is not necessary in this exemplary embodiment to retrain the predictive model, the predictive model can be re-trained any number times such that actions 525 through 540 are repeated until a satisfactory output is achieved or some other parameter has been met. As a nonlimiting example, the user can adjust the weighted relationship between the input layer and the one or more hidden layers of a neural network discussed with further reference to FIG. 6. If a satisfactory output has been recorded, then in action 545 one or more predictive models can be generated. It is understood that the predictive model, once generated, can undergo further training like actions 520 to 545. Having generated the predictive model, in action 550 the model can generate one or more object detections within any number of image frames.

FIG. 6 is a diagram illustrating a neural network as an exemplary embodiment for the predictive model. A neural network is a series of algorithms that can, under predetermined training restrictions, recognize relationships between one or more variables. A neuron in a neural network is a mathematical function that collects and classifies information according to a specific form set by a user. A neural network can be divided into three main components: an input layer, a processing or hidden layer, and an output layer. The input layer comprises data sets chosen to be inserted into the neural network for analysis. The hidden layers include one or more neurons that can classify the inputs according to parameters set by the user. The hidden layers can comprise multiple successive layers, the first layer positioned immediately after the input layer and the last layer positioned immediately before the output layer. The hidden layer immediately after the input layer may be connected to the input layer via a predetermined weight or emphasis. These weights can be assigned according to the modeler's agenda. Alternatively, the model itself can determine the optimal weights between layers such that a predetermined outcome, margin of error, or minimum data point is achieved.

The predictive model can comprise a neural network 600. The neural network may be integrated into the server, the image processor, or some other computer device suitable for neural network analysis. The sever can be associated with the image processor itself. The neural network can include an input layer 605, one or more hidden layers 625, and an output layer 635. Although only a certain number of nodes are depicted in FIG. 6, it is understood that the neural network according to the disclosed embodiments may include less or more nodes in each layer. Additionally, the hidden layers can include more or less layers than what is depicted in FIG. 6. It is also understood that the connections between each layer may be assigned a predetermined weight according to user's manual change or according to some weight value generated by the neural network itself. The input layer may include sets of data gathered from outside sources. As a nonlimiting example, the neural network can include frame content 610, frame timing 615 (e.g. t=0, t=−0.25, etc.), and camera movement 620 which may be observed by the image processor. Upon analyzing the inputs via the one or more hidden layers, the neural network can create one or more object detections 640. It is understood that one or more neural networks or some combination of neural networks can be trained according to individual users. It is understood that any of the neural networks described herein may be trained or iterated any number of times. In some embodiments, the neural network can be re-trained and/or updated. In still other embodiments, the neural network can be trained until a sufficient level of accuracy of object detection has been reached.

In some embodiments, the application can analyze biometric using a predictive model including without limitation a recursive neural network (RNN), convolutional neural network (CNN), artificial neural network (ANN), or some other neural network. The predictive models described herein can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

The exemplary system, method and computer-readable medium can utilize various neural networks, such as CNNs or RNNs, to generate the exemplary models. A CNN can include one or more convolutional layers (e.g., often with a subsampling step) and then followed by one or more fully connected layers as in a standard multilayer neural network. CNNs can utilize local connections, and can have tied weights followed by some form of pooling which can result in translation invariant features.

A RNN is a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. A RNN can generally refer to two broad classes of networks with a similar general structure, where one is finite impulse and the other is infinite impulse. Both classes of networks exhibit temporal dynamic behavior. A finite impulse recurrent network can be, or can include, a directed acyclic graph that can be unrolled and replaced with a strictly feedforward neural network, while an infinite impulse recurrent network can be, or can include, a directed cyclic graph that may not be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory, and can be part of long short-term memory networks (LSTMs) and gated recurrent units.

RNNs can be similar to a network of neuron-like nodes organized into successive “layers,” each node in a given layer being connected with a directed e.g., (one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data en route from input to output). RNNs can accept an input vector x and give an output vector y. However, the output vectors are based not only by the input just provided in, but also on the entire history of inputs that have been provided in in the past.

For supervised learning in discrete time settings, sequences of real-valued input vectors can arrive at the input nodes, one vector at a time. At any given time step, each non-input unit can compute its current activation (e.g., result) as a nonlinear function of the weighted sum of the activations of all units that connect to it. Supervisor-given target activations can be supplied for some output units at certain time steps. For example, if the input sequence is a speech signal corresponding to a spoken digit, the final target output at the end of the sequence can be a label classifying the digit. In reinforcement learning settings, no teacher provides target signals. Instead, a fitness function, or reward function, can be used to evaluate the RNNs performance, which can influence its input stream through output units connected to actuators that can affect the environment. Each sequence can produce an error as the sum of the deviations of all target signals from the corresponding activations computed by the network. For a training set of numerous sequences, the total error can be the sum of the errors of all individual sequences.

The models described herein may be trained on one or more training datasets, each of which may comprise one or more types of data. In some examples, the training datasets may comprise previously-collected data, such as data collected from previous uses of the same type of systems described herein and data collected from different types of systems. In other examples, the training datasets may comprise continuously-collected data based on the current operation of the instant system and continuously-collected data from the operation of other systems. In some examples, the training dataset may include anticipated data, such as the anticipated future workloads, currently scheduled workloads, and planned future workloads, for the instant system and/or other systems. In other examples, the training datasets can include previous predictions for the instant system and other types of system, and may further include results data indicative of the accuracy of the previous predictions. In accordance with these examples, the predictive models described herein may be training prior to use and the training may continue with updated data sets that reflect additional information.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

The predictive models described herein can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

The exemplary system, method and computer-readable medium can utilize various neural networks, such as convolutional neural networks (CNNs) or recurrent neural networks (RNNs), to generate the exemplary models. A CNN can include one or more convolutional layers (e.g., often with a subsampling step) and then followed by one or more fully connected layers as in a standard multilayer neural network. CNNs can utilize local connections, and can have tied weights followed by some form of pooling which can result in translation invariant features.

A RNN is a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. A RNN can generally refer to two broad classes of networks with a similar general structure, where one is finite impulse and the other is infinite impulse. Both classes of networks exhibit temporal dynamic behavior. A finite impulse recurrent network can be, or can include, a directed acyclic graph that can be unrolled and replaced with a strictly feedforward neural network, while an infinite impulse recurrent network can be, or can include, a directed cyclic graph that may not be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory, and can be part of long short-term memory networks (LSTMs) and gated recurrent units.

RNNs can be similar to a network of neuron-like nodes organized into successive “layers,” each node in a given layer being connected with a directed e.g., (one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data en route from input to output). RNNs can accept an input vector x and give an output vector y. However, the output vectors are based not only by the input just provided in, but also on the entire history of inputs that have been provided in in the past.

For supervised learning in discrete time settings, sequences of real-valued input vectors can arrive at the input nodes, one vector at a time. At any given time step, each non-input unit can compute its current activation (e.g., result) as a nonlinear function of the weighted sum of the activations of all units that connect to it. Supervisor-given target activations can be supplied for some output units at certain time steps. For example, if the input sequence is a speech signal corresponding to a spoken digit, the final target output at the end of the sequence can be a label classifying the digit. In reinforcement learning settings, no teacher provides target signals. Instead, a fitness function, or reward function, can be used to evaluate the RNNs performance, which can influence its input stream through output units connected to actuators that can affect the environment. Each sequence can produce an error as the sum of the deviations of all target signals from the corresponding activations computed by the network. For a training set of numerous sequences, the total error can be the sum of the errors of all individual sequences.

The models described herein may be trained on one or more training datasets, each of which may comprise one or more types of data. In some examples, the training datasets may comprise previously-collected data, such as data collected from previous uses of the same type of systems described herein and data collected from different types of systems. In other examples, the training datasets may comprise continuously-collected data based on the current operation of the instant system and continuously-collected data from the operation of other systems. In some examples, the training dataset may include anticipated data, such as the anticipated future workloads, currently scheduled workloads, and planned future workloads, for the instant system and/or other systems. In other examples, the training datasets can include previous predictions for the instant system and other types of system, and may further include results data indicative of the accuracy of the previous predictions. In accordance with these examples, the predictive models described herein may be training prior to use and the training may continue with updated data sets that reflect additional information.

In some aspects, the techniques described herein relate to a method for tracking objects in a video including: receiving, by a processor, one or more frames of a video; dividing, by the processor, each frame of a video into non-overlapping sub-images; extracting, by the processor, keypoints from each sub-image; finding, by the processor, keypoint matches between the keypoints and one or more predetermined features, wherein the keypoint matches occur only between keypoints within the same sub-image of a prior frame and a current frame; estimating, by the processor, an affine transformation by analyzing the resulting keypoint matches; and align, by the processor, the prior frame to the current frame using the affine transformation.

In some aspects, the techniques described herein relate to a method, wherein the sub-images are non-overlapping and arranged in a grid.

In some aspects, the techniques described herein relate to a method, wherein the keypoints are detected by a keypoint detection algorithm.

In some aspects, the techniques described herein relate to a method, wherein the keypoints represented one or more distinctive features within the sub-image.

In some aspects, the techniques described herein relate to a method, wherein the method further includes: generating, by the processor upon extracting the keypoints, one or more keypoint descriptors by extracting raw pixel information within a patch surrounding each keypoint.

In some aspects, the techniques described herein relate to a method, wherein the affine transformation compensates for a camera motion between the prior frame and the current frame.

In some aspects, the techniques described herein relate to a method, wherein the alignment of the prior frame with the current frame stabilizes the video by compensating for camera motion between the current frame and prior frame.

In some aspects, the techniques described herein relate to a method, wherein the method further includes: detecting, by the processor, one or more objects present in one or more stabilized frames via a trained objection detection algorithm.

In some aspects, the techniques described herein relate to a method, wherein the objection detection algorithm is a convolutional neural network (CNN).

In some aspects, the techniques described herein relate to a method, wherein the CNN uses no more then three stabilized frames to detect the one or more objects.

In some aspects, the techniques described herein relate to a video stabilization system including: a processor configured to: receiving one or more frames of a video; dividing each frame of a video into non-overlapping sub-images; extracting keypoints from each sub-image; finding keypoint matches between the keypoints and one or more predetermined features, wherein the keypoint matches occur only between keypoints within the same sub-image of a prior frame and a current frame; estimating an affine transformation by analyzing the resulting keypoint matches; and align the prior frame to the current frame using the affine transformation.

In some aspects, the techniques described herein relate to a system, wherein the processor is further configured to detect one or more objects present in one or more stabilized frames via a trained objection detection algorithm.

In some aspects, the techniques described herein relate to a system, wherein the processor is further configured to generate one or more bounding boxes around the one or more objects.

In some aspects, the techniques described herein relate to a system, wherein the objects include at least one selected from the group of a human being, vehicle, or machinery.

In some aspects, the techniques described herein relate to a system, wherein the objection detection algorithm is a convolutional neural network (CNN).

In some aspects, the techniques described herein relate to a system, wherein the CNN uses no more than three stabilized frames to detect the one or more objects.

In some aspects, the techniques described herein relate to a system, wherein the processor is further configured to store the one or more frames in a database.

In some aspects, the techniques described herein relate to a system, wherein the processor is further configured to retrieve a predetermined amount of frames from the data storage unit for processing.

In some aspects, the techniques described herein relate to a system, wherein the processor is configured to process only three frames.

In some aspects, the techniques described herein relate to a system, wherein the processor is configured receive camera movement data from an inertial measurement unit (IMU).

In some aspects, the techniques described herein relate to a non-transitory computer readable medium containing computer executable instructions that, when executed by a wearable device including a processor, configure the computer hardware arrangement to perform procedures including: receiving one or more frames of a video; dividing each frame of a video into non-overlapping sub-images; extracting keypoints from each sub-image; finding keypoint matches between the keypoints of each sub-image and one or more predetermined features, wherein the keypoint matches occur only between keypoints within the same sub-image of a prior frame and a current frame; estimating an affine transformation by analyzing the resulting keypoint matches; and align the prior frame to the current frame using the affine transformation.

Further, it is to be understood that the terminology used herein is for the purpose of describing particular embodiments only and is not intended to be limiting. The terms “a” or “an” as used herein, are defined as one or more than one. The term “plurality” as used herein, is defined as two or more than two. The term “another” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

In the invention, various embodiments make reference to next images, next detections, next data, or next information as processed by the systems and methods described. It is understood that in the context of these embodiments, any reference to next images, etc. can be understood as referring to a next time-step. In the context of motion tracking, a “time-step” refers to the discrete intervals or time increments at which motion data is captured or recorded. It represents the temporal resolution or frequency at which the positions or movements of tracked objects or subjects are sampled. Motion tracking systems typically measure the position, orientation, or other kinematic parameters of objects or subjects in real-time. To capture the dynamic motion accurately, the tracking system needs to update or sample the position data at regular intervals. These intervals are defined by the time-step. A smaller time-step or shorter time interval between samples provides a higher temporal resolution, allowing for more precise tracking of fast or subtle movements. However, a smaller time-step also increases the amount of data generated, potentially requiring more processing power and storage capacity. Conversely, a larger time-step or longer time interval between samples reduces the temporal resolution but decreases the amount of data generated. This can be useful in situations where the motion being tracked is relatively slow or when there are constraints on processing power or storage resources. It is understood that the time-steps may remain constant throughout the systems and methods described herein. In other embodiments, the time-steps may be dynamically changed or adjusted by the tracker according to the needs and limits of the associated processors and servers responsible for tracking the objects.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output.

Method steps also may be performed by, and an apparatus may be implemented as, special purpose logic circuitry, e.g., an FPGA (field programmable gate array) or an ASIC (application specific integrated circuit).

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

What is claimed is:

1. A method for tracking objects in a video comprising:
receiving, by a processor, one or more frames of a video;
dividing, by the processor, each frame of a video into non-overlapping sub-images;
extracting, by the processor, keypoints from each sub-image;
finding, by the processor, keypoint matches between the keypoints and one or more predetermined features, wherein the keypoint matches occur only between keypoints within the same sub-image of a prior frame and a current frame;
estimating, by the processor, an affine transformation by analyzing the resulting keypoint matches; and
align, by the processor, the prior frame to the current frame using the affine transformation.

2. The method of claim 1, wherein the sub-images are non-overlapping and arranged in a grid.

3. The method of claim 1, wherein the keypoints are detected by a keypoint detection algorithm.

4. The method of claim 1, wherein the keypoints represented one or more distinctive features within the sub-image.

5. The method of claim 1, wherein the method further comprises:
generating, by the processor upon extracting the keypoints, one or more keypoint descriptors by extracting raw pixel information within a patch surrounding each keypoint.

6. The method of claim 1, wherein the affine transformation compensates for a camera motion between the prior frame and the current frame.

7. The method of claim 6, wherein the alignment of the prior frame with the current frame stabilizes the video by compensating for camera motion between the current frame and prior frame.

8. The method of claim 1, wherein the method further comprises:
detecting, by the processor, one or more objects present in one or more stabilized frames via a trained objection detection algorithm.

9. The method of claim 8, wherein the objection detection algorithm is a convolutional neural network (CNN).

10. The method of claim 9, wherein the CNN uses no more then three stabilized frames to detect the one or more objects.

11. A video stabilization system comprising:
a processor configured to:
receiving one or more frames of a video;
dividing each frame of a video into non-overlapping sub-images;
extracting keypoints from each sub-image;
finding keypoint matches between the keypoints and one or more predetermined features, wherein the keypoint matches occur only between keypoints within the same sub-image of a prior frame and a current frame;
estimating an affine transformation by analyzing the resulting keypoint matches; and
align the prior frame to the current frame using the affine transformation.

12. The system of claim 11, wherein the processor is further configured to detect one or more objects present in one or more stabilized frames via a trained objection detection algorithm.

13. The system of claim 12, wherein the processor is further configured to generate one or more bounding boxes around the one or more objects.

14. The system of claim 13, wherein the objects include at least one selected from the group of a human being, vehicle, or machinery.

15. The system of claim 14, wherein the objection detection algorithm is a convolutional neural network (CNN).

16. The system of claim 15, wherein the CNN uses no more than three stabilized frames to detect the one or more objects.

17. The system of claim 11, wherein the processor is further configured to store the one or more frames in a database.

18. The system of claim 17, wherein the processor is further configured to retrieve a predetermined amount of frames from the data storage unit for processing.

19. The system of claim 11, wherein the processor is configured receive camera movement data from an inertial measurement unit (IMU).

20. A non-transitory computer readable medium containing computer executable instructions that, when executed by a wearable device comprising a processor, configure the computer hardware arrangement to perform procedures comprising:
receiving one or more frames of a video;
dividing each frame of a video into non-overlapping sub-images;
extracting keypoints from each sub-image;
finding keypoint matches between the keypoints of each sub-image and one or more predetermined features, wherein the keypoint matches occur only between keypoints within the same sub-image of a prior frame and a current frame;
estimating an affine transformation by analyzing the resulting keypoint matches; and
align the prior frame to the current frame using the affine transformation.
